(19) United States
(12) Patent Application Publication
(10) Pub. No.: US 2026/0307391 A1
(43) Pub. Date: Oct. 8, 2026

(54) INKJET RECORDING APPARATUS

(71) Applicant: KYOCERA Document Solutions Inc., Osaka (JP)

(72) Inventors: Shuhei KAWAMATA, Osaka (JP); Yuko YANO, Osaka (JP); Shunsuke YAMASAKI, Osaka (JP); Noriaki FURUKAWA, Osaka (JP); Yasutaka INUI, Osaka (JP)

(73) Assignee: KYOCERA Document Solutions Inc., Osaka (JP)

(21) Appl. No.: 19/636,664

(22) Filed: Apr. 1, 2026

(30) Foreign Application Priority Data
Apr. 7, 2025 (JP) 2025-062899

(51) Int. Cl. B41J 2/17; B41J 2/165

(52) U.S. Cl. CPC B41J 2/1721; B41J 2/16552; B41J 2002/16558

(57) ABSTRACT

An inkjet recording apparatus includes a recording head, an ink collection tray, a driving device, a discharge tube, a waste ink storage container, and a control portion. The driving device reciprocates the ink collection tray between a first and a second position. An accommodation space that can accommodate the discharge tube is formed below the ink collection tray. The discharge tube is made of a flexible material with a predetermined restoring force and elastically deforms to enter the accommodation space to be accommodated in it while the ink collection tray is moving from the first position to the second position.

### INCORPORATION BY REFERENCE

This application is based on and claims the benefit of priority from Japanese Patent Application No. 2025-062899 filed on Apr. 7, 2025, the contents of which are hereby incorporated by reference.

### BACKGROUND

The present disclosure relates to an inkjet recording apparatus.

As recording apparatuses such as facsimile machines, multifunction peripherals, and printers, inkjet recording apparatuses are widely used that form an image by ejecting ink to a recording medium (e.g., sheets of paper, OHP sheets, and the like).

Such inkjet recording apparatuses generally include a recording head, an ink ejecting nozzle, and an ink collection tray, a discharge tube, a waste ink storage container, and a driving device. The recording head has an ink ejection surface from which ink is ejected. The ink ejection surface has an opening formed in it for ejecting ink. The ink ejecting nozzle is connected to the opening and supplies ink through the opening to the ink ejection surface. The ink collection tray is a tray that can store liquid containing the ink falling from the recording head.

One end of the discharge tube is connected to the ink collection tray and the other end of it is connected to the waste ink storage container. The liquid stored in the ink collection tray is discharged through the discharge tube into the waste ink storage container. The driving device reciprocates the ink collection tray between a first position (a position where the ink collection tray faces the ink ejection surface) and a second position (a position where the ink collection tray does not face the ink ejection surface).

The inkjet recording apparatus performs recovery operation with predetermined timing (such as when starting printing after a long period of inactivity and during intervals between printing sessions) to clean the ink ejection surface. Specifically, the operation proceeds as follows.

The driving device moves the ink collection tray to the first position. Ink is forcibly pushed out of the ink ejecting nozzle (purging). Pushing out ink allows thickened ink, air bubbles, foreign matter, and the like in the nozzle to be discharged. Furthermore, the pushed-out ink redissolves the mist (ink residue) attached to the ink ejection surface. And after the ink is pushed out, the ink attached to the ink ejection surface (nozzle face) is wiped off with a blade-form wiper. Then, the driving device moves the ink collection tray to the second position.

The ink wiped off by the wiper falls onto the ink collection tray. The fallen ink passes through the discharge tube as waste liquid to be discharged into the waste ink storage container.

### SUMMARY

According to one aspect of the present disclosure, an inkjet recording apparatus includes a recording head, an ink collection tray, a driving device, a discharge tube, a waste ink storage container, and a control portion. The recording head has an ink ejection surface from which ink is ejected. The ink collection tray is disposed at a first position facing the ink ejection surface during recovery operation for the recording head and can store liquid containing ink falling from the ink ejection surface. The driving device gives a driving force to the ink collection tray to reciprocate the ink collection tray between the first position and a second position where the ink collection tray does not face the ink ejection surface. The discharge tube has one end connected to the ink collection tray, and discharges the liquid stored in the ink collection tray from one end to the other end. The waste ink storage container is connected to the other end of the discharge tube and receives and stores the liquid discharged from the discharge tube. The control portion controls the driving device such that the ink collection tray is located at the first position when the recovery operation for the recording head is in progress, and that the ink collection tray is located at the second position when the recovery operation is not in progress. An accommodation space that can accommodate the discharge tube is formed below the ink collection tray. The discharge tube is made of a flexible material with a predetermined restoring force and elastically deforms to enter the accommodation space to be accommodated in it while the ink collection tray is moving from the first position to the second position.

### BRIEF DESCRIPTION OF THE DRAWINGS

FIG. 1 is a side sectional view showing an outline of the construction of a printer according to a first embodiment of the present disclosure.

FIG. 2 is a block diagram showing the configuration of a control portion.

FIG. 3 is a plan view of a recording portion.

FIG. 4 is a perspective view of the recording portion as seen from above.

FIG. 5 is a side view of a recording head.

FIG. 6 is a plan view of the recording head as seen from an ink ejection surface side.

FIG. 7 is a perspective view of a maintenance unit, at a first position, and the recording portion.

FIG. 8 is a plan view, as seen from the side, of the maintenance unit and the recording portion in FIG. 7.

FIG. 9 is a perspective view of the maintenance unit, at a second position, and the recording portion.

FIG. 10 is a plan view of an ink collection tray at the first position as seen in the sheet conveying direction.

FIG. 11 is a plan view, as seen from above, of the ink collection tray at the first position.

FIG. 12 is a plan view, as seen from above, of the ink collection tray at the second position.

### DETAILED DESCRIPTION

### 1. Outline of the construction of a printer 100

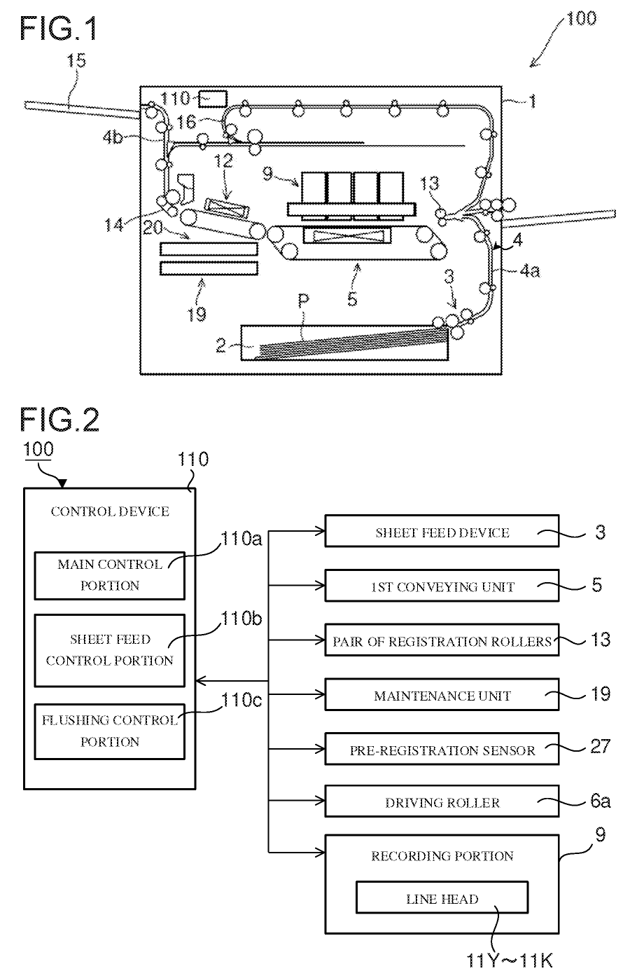

A first embodiment of the present disclosure will be described below with reference to the accompanying drawings. FIG. 1 is a side sectional view showing an outline of the construction of a printer 100 according to the first embodiment of the present disclosure. The printer 100 is an inkjet printer (one example of an inkjet recording apparatus). As shown in FIG. 1, the printer 100 includes a sheet feed cassette 2, a sheet feed device 3, a sheet conveying passage 4, a pair of registration rollers 13, a first conveying unit 5, a recording portion 9, a second conveying unit 12, a decurler portion 14, a sheet discharge tray 15, a maintenance unit 19, and a cap unit 20.

The sheet feed cassette 2 is a sheet storage portion that stores sheets in it. The sheet feed cassette 2 is disposed in a lower part of the body of the printer 100. In the sheet feed cassette 2, sheets P as one example of a recording medium are stored.

The sheet feed device 3 is disposed downstream of the sheet feed cassette 2 in the sheet conveying direction (i.e., to the upper right of the sheet feed cassette 2 in FIG. 1). The sheet feed device 3 separates and feeds out one sheet after another from the stack of sheets P in the sheet feed cassette 2 downstream in the sheet conveying direction (more specifically, into a first sheet conveying passage 4a, which will be described later).

The sheet conveying passage 4 is a conveying passage for sheets P provided in the printer 100. The sheet conveying passage 4 includes a first sheet conveying passage 4a, a reversing conveying passage 16, and a second sheet conveying passage 4b. The pair of registration rollers 13 and the decurler portion 14 are disposed midway along the sheet conveying passage 4.

The first sheet conveying passage 4a is located ahead in the sheet feed direction with respect to the sheet feed cassette 2 (i.e., downstream in the sheet conveying direction, to the upper right in FIG. 1). The first sheet conveying passage 4a extends vertically upward along a side face of the printer 100. The downstream end of the first sheet conveying passage 4a in the sheet conveying direction is connected to the pair of registration rollers 13 and the reversing conveying passage 16. The first sheet conveying passage 4a conveys the sheet P fed out from the sheet feed cassette 2 to the pair of the registration rollers 13.

The pair of registration rollers 13 corrects a skew of the conveyed sheet P and, with predetermined timing (i.e., the timing of the ink ejection operation performed by the recording portion 9), feeds out the sheet P toward the first conveying unit 5 (in particular, toward a first conveying belt 8, which will be described later). When an image is formed on the back side of the sheet P, the pair of registration rollers 13 receives the sheet P from the first conveying unit 5 to convey it to the reversing conveying passage 16.

The second sheet conveying passage 4b is disposed downstream of the decurler portion 14 in the sheet conveying direction. The second sheet conveying passage 4b feeds out the sheet P fed from the decurler portion 14 to the sheet discharge tray 15 or to the reversing conveying passage 16. Specifically, when the sheet P is subjected to duplex recording, the second sheet conveying passage 4b feeds it out to the reversing conveying passage 16. On the other hand, when the sheet P is not subjected to duplex recording, the second sheet conveying passage 4b feeds it out to the discharge tray 15.

One end of the reversing conveying passage 16 (the upstream end in the sheet conveying direction) is connected to the second sheet conveying passage 4b. The other end of the reversing conveying passage 16 (the downstream end in the sheet conveying direction) is connected to the pair of registration rollers 13. The reversing conveying passage 16 feeds the sheet P fed from the second sheet conveying passage 4b back to the pair of registration rollers 13 with its front and back sides reversed.

The first conveying unit 5 and the recording portion 9 are disposed closely downward of the pair of registration rollers 13 in the sheet conveying direction. The first conveying unit 5 includes the first conveying belt 8, a driving roller 6a, and a driven roller 6b.

The first conveying belt 8 is an endless belt. The first conveying belt 8 is stretched across a plurality of rollers including the driving roller 6a and the driven roller 6b under a predetermined tension. As the driving roller 6a rotates, the first conveying belt 8 rotates with the frictional force between the driving roller 6a and the first conveying belt 8. The first conveying belt 8 conveys the sheet P having an image formed on it to the second conveying unit 12.

The first conveying belt 8 conveys the sheet P fed to it by the pair of registration rollers 13 to a position facing the recording portion 9 (in particular, recording heads 17a to 17c, which will be described later). The first conveying belt 8 then feeds out the sheet P having the image formed on it by the recording portion 9 to the second conveying unit 12.

The recording portion 9 is disposed above the first conveying belt 8. The recording portion 9 ejects ink onto the sheet P at the position facing it. This records an image on the sheet P. The ejection of ink in the recording portion 9 is controlled by a control portion 110 in the printer 100. The configuration of the recording portion 9 will be described in detail later.

The second conveying unit 12 is disposed downstream (left in FIG. 1) of the first conveying unit 5 in the sheet conveying direction. The second conveying unit 12 receives the sheet P having the image recorded on it by the recording portion 9 and feeds it out to the decurler portion 14. The ink ejected onto the surface of the sheet P dries while it passes through the second conveying unit 12.

The decurler portion 14 receives the sheet P fed from the second conveying unit 12 and decurls curls in the sheet P. The decurler portion 14 feeds out the sheet P to the second sheet conveying passage 4b.

The maintenance unit 19 and the cap unit 20 are disposed below the second conveying unit 12. When purging is performed, the maintenance unit 19 moves horizontally to below the recording portion 9, wipes off the ink pushed out from the recording portion 9 (more specifically, from ink ejection ports 18 in the recording heads 17a to 17c, which will be described later), and collects the wiped-off ink. Purging refers to operation of forcibly pushing ink out of the ink ejection ports 18 in the recording heads 17a to 17c to discharge thickened ink, foreign matter, and air bubbles in the ink ejection ports 18.

When capping of ink ejection surfaces F1 of the recording heads 17a to 17c is performed, the cap unit 20 moves horizontally to below the recording portion 9 and then upward to be attached to the lower face of the recording heads 17a to 17c.

Next, the control portion 110 will be described. FIG. 2 is a block diagram showing the configuration of the control portion 110. The control portion 110 is configured to include, for example, a CPU (central processing unit) and memory. Specifically, as shown in FIG. 2, the control portion 110 includes a main control portion 110a, a sheet feed control portion 110b, and a flushing control portion 110c. Furthermore, the control portion 110 is electrically connected to different devices in the printer 100 (see FIG. 2) and is configured to be able to control the operation of different parts of the printer 100.

The main control portion 110a controls the driving of different rollers in the printer 100, the driving of the driving roller 6a (the conveying speed of the sheet P), the ejection of ink from the recording portion 9 during image recording, and the like. The sheet feed control portion 110b controls the pair of registration rollers 13 and the sheet feed device 3. For example, based on the detection timing of the sheet P by a sheet detection sensor (e.g., a pre-registration sensor 27) provided in the sheet conveying passage 4, the sheet feed control portion 110b controls the pair of registration rollers 13. This controls the timing of the conveyance of the subsequent sheet P. The flushing control portion 110c controls the recording portion 9 and the first conveying unit 5 to perform flushing (including recovery operation, which will be described later).

### 2. Detailed configuration of the recording portion 9

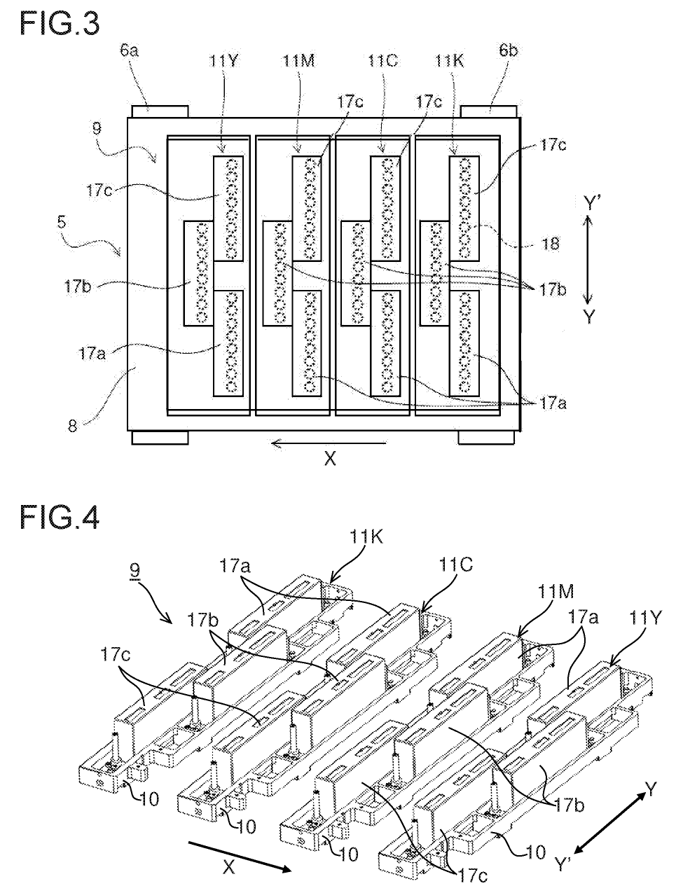

FIG. 3 is a plan view of the recording portion 9. FIG. 4 is a perspective view of the recording portion 9 as seen from above. As shown in FIGS. 3 and 4, the recording portion 9 includes line heads 11Y, 11M, 11C, and 11K. The line heads 11Y to 11K are disposed at a predetermined interval (e.g., 1 mm) along the height direction relative to the conveying surface of the first conveying belt 8. The driving roller 6a drives the first conveying belt 8 to run in the conveying direction of the sheet P (the direction of arrow X).

Each of the line heads 11Y to 11K has the recording heads 17a to 17c. The recording heads 17a to 17c in each of the line heads 11Y to 11Kare held in a head housing 10. From the line heads 11Y to 11K, through the recording heads 17a to 17c (more specifically, through the ink ejection ports 18 in the recording heads 17a to 17c, which will be described later), inks (water-based inks in this embodiment) of different colors of yellow (Y), magenta (M), cyan (C), and black (K) are ejected.

The recording heads 17a to 17c are arranged in a staggered pattern along the sheet width direction (the direction of arrow YY’) that intersects the sheet conveying direction (the direction of arrow X). The recording heads 17a to 17c are respectively fed with inks of four colors (yellow, magenta, cyan, and black) stored in ink tanks (not illustrated), corresponding to the colors of the line heads 11Y to 11K.

Based on control signals from the main control portion 110a, the recording heads 17a to 17c eject ink from their tip ends (more specifically, from the ink ejection ports 18, which will be described later) toward the sheet P on the first conveying belt 8. This forms, on the sheet P, a color image having yellow, magenta, cyan, and black inks overlaid on each other.

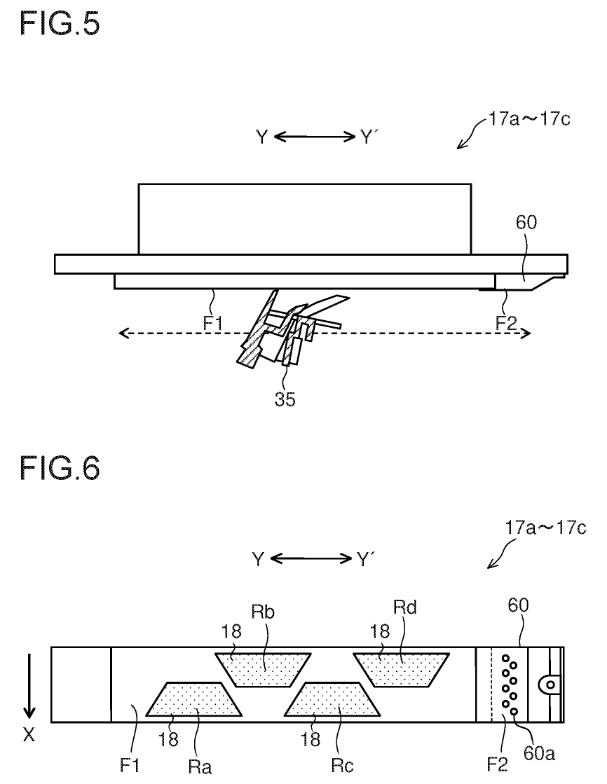

FIG. 5 is a side view of the recording heads 17a to 17c. FIG. 6 is a plan view of the recording heads 17a to 17c as seen from the ink ejection surface F1 side. The recording heads 17a to 17c have the same shape and configuration, and are thus shown in a common diagram in FIGS. 5 and 6. The following description focuses on the recording head 17b and, for the recording heads 17a and 17c, no overlapping description will be repeated.

As shown in FIGS. 5 and 6, the recording head 17b has the ink ejection surface F1, a plurality of ink ejection ports 18 (nozzles), and a cleaning liquid supply surface F2.

The ink ejection surface F1 is the surface located at the tip end of the recording head 17b. The ink ejection surface F1 is a flat surface parallel to horizontal directions (the sheet width direction and the sheet conveying direction). The ink ejection ports 18 are formed in the ink ejection surface F1. The ink ejection ports 18 are arrayed at equal intervals along the intersecting direction (the direction of arrow YY’).

The ink ejection surface F1 is made of, for example, SUS (stainless steel). A water-repellent film (not illustrated) is formed on the ink ejection surface F1. The ink ejection surface F1 is provided with a plurality (here, four blocks) of nozzle regions Ra to Rd. A large number of ink ejection ports 18 (see FIG. 3) are arranged in each of the nozzle regions Ra to Rd. In FIG. 6, the ink ejection ports 18 are indicated by a large number of tiny dots.

The cleaning liquid supply surface F2 is the surface located at the tip end of the recording head 17b. The cleaning liquid supply surface F2 is located at one end of the recording head 17b along the longitudinal direction (horizontal direction). The cleaning liquid supply surface F2 is adjacent to the ink ejection surface F1 in the sheet conveying direction. The cleaning liquid supply surface F2 is provided with a cleaning liquid supply portion 60. The cleaning liquid supply portion 60 supplies cleaning liquid, as will be described in more detail below.

The cleaning liquid supply portion 60 is provided with a large number of cleaning liquid supply ports 60a. The cleaning liquid supply ports 60a are connected to a cleaning liquid storage tank (not illustrated). During recovery operation, which will be described later, the cleaning liquid is supplied from the cleaning liquid storage tank to the cleaning liquid supply surface F2 through the cleaning liquid supply ports 60a.

### 3. Detailed configuration of the maintenance unit 19

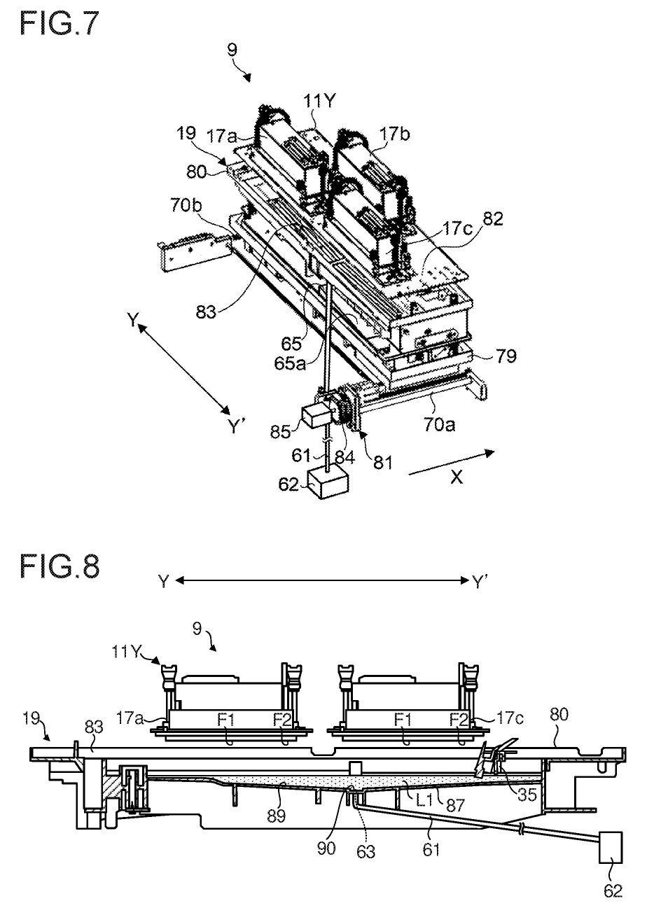

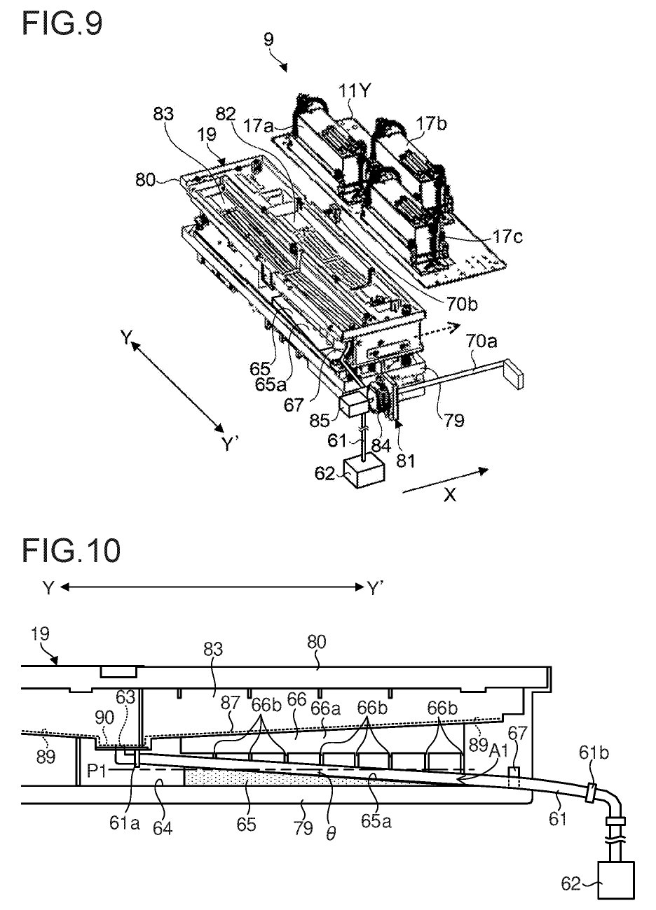

FIG. 7 is a perspective view of the maintenance unit 19, at a first position, and the recording portion 9. FIG. 8 is a plan view, as seen from the side, of the maintenance unit 19 and the recording portion 9 in FIG. 7. FIG. 9 is a perspective view of the maintenance unit 19, at a second position, and the recording portion 9. While FIGS. 7 to 9 show only the line head 11Y out of the line heads 11Y to 11K and the following description basically focuses on the relationship between the line head 11Y and the maintenance unit 19, a similar configuration and relationship apply to the line heads 11M to 11K.

As shown in FIGS. 7 and 8, when flushing is performed, the maintenance unit 19 is disposed below the line head 11Y. In this state, the maintenance unit 19 performs recovery operation (details will be given later) for the recording heads 17a to 17c of the line heads 11Y.

As shown in FIGS. 7 to 9, the maintenance unit 19 includes a driving device 81, a base portion 79, a guide spacer 65, a wiper 35, an ink collection tray 80, a discharge tube 61, and a waste ink storage container 62.

The driving device 81 gives a driving force to the ink collection tray 80 to reciprocate it between a first and a second position. The first position is a position where the ink collection tray 80 faces the recording heads 17a to 17c along the top-bottom direction (the position shown in FIGS. 7 and 8). The second position is a position where the ink collection tray 80 is displaced horizontally (in the direction opposite to arrow X in the figure) from the first position so that the ink collection tray 80 does not face the recording heads 17a to 17c along the top-bottom direction (the position shown in FIG. 9). The detailed configuration of the driving device 81 is as follows.

As shown in FIGS. 7 to 9, the driving device 81 includes guide rails 70a and 70b, a drive transmission portion 84, and a drive source 85.

The guide rails 70a and 70b are parallel to the sheet conveying direction (the direction of arrow X). The guide rails 70a and 70b are fixed at positions below the recording portion 9. The guide rail 70a is coupled to one end of the base portion 79 along the horizontal direction (the end at side Y’ of arrow YY’ in the figure). The guide rail 70b is coupled to the other end of the base portion 79 along the horizontal direction (the end at side Y of arrow YY’ in the figure). The guide rails 70a and 70b guide the movement of the base portion 79 along the sheet conveying direction.

The drive transmission portion 84 is configured with a plurality of gears and the like. The drive source 85 is a driving device such as a motor. The drive source 85 outputs a driving force in a rotational direction. The drive transmission portion 84 is connected to the base portion 79 and the drive source 85. The drive transmission portion 84 transmits the driving force output from the drive source 85 to the base portion 79.

The base portion 79 (one example of a facing portion) is disposed below the ink collection tray 80. The ink collection tray 80 is fixed to the base portion 79. As described above, the base portion 79 is movable along the sheet conveying direction while being guided along the guide rails 70a and 70b. As the base portion 79 moves along the sheet conveying direction, the ink collection tray 80 moves together with the base portion 79 between the first and second positions.

FIG. 10 is a plan view of the ink collection tray 80 at the first position as seen in the sheet conveying direction. As shown in FIG. 10, an accommodation space A1 is formed below the ink collection tray 80, between the ink collection tray 80 and the base portion 79. The accommodation space A1 is a space in which the discharge tube 61 is accommodated when the ink collection tray 80 is at the first position. The accommodation space A1 will be described in detail later.

The base portion 79 faces the ink collection tray 80 across the accommodation space A1 along the top-bottom direction. The base portion 79 has a first opposing face 64 and a projection 67. The first opposing face 64 is the upper face of the base portion 79 and faces the ink collection tray 80 along the top-bottom direction. A lower end part of the ink collection tray 80 makes contact with the first opposing face 64.

The projection 67 is provided near one end of the ink collection tray 80 along the sheet width direction (the direction of arrow YY’). The projection 67 protrudes upward from the first opposing face 64. The projection 67 has a cylindrical shape.

The guide spacer 65 is provided on the first opposing face 64. The guide spacer 65 is provided at a position closer to the bottom groove portion 90 than the projection 67 along the sheet width direction (the direction of arrow YY’).

The guide spacer 65 protrudes upward from the first opposing face 64 toward the ink collection tray 80. The guide spacer 65 is in the shape of a triangular prism with a top face and a bottom face at its opposite ends along the sheet conveying direction. The guide spacer 65 is made of a relatively slippery material (for example, a material with a low coefficient of friction on its surface). The guide spacer 65 is made of polyacetal resin.

The guide spacer 65 has a second opposing face 65a. The second opposing face 65a is, of the side faces of the guide spacer 65, the face that faces the ink collection tray 80 along the top-bottom direction. The second opposing face 65a is inclined to have a downward slope along the sheet width direction from its end closer to the middle of the ink collection tray 80 (at side Y of the arrow) to its end farther from the middle (at side Y’ of the arrow).

The inclination angle θ of the second opposing face 65a is at least three degrees or more. The inclination angle θ is an angle with respect to a horizontal plane P1. In other words, the inclination angle θ is the angle between the horizontal plane P1 and the second opposing face 65a.

The wiper 35 is disposed above the ink collection tray 80 (see FIG. 8). More specifically, the wipers 35 are disposed one above a water storage portion 87 of each of a first and a second collection portions 82 and 83, which will be described later.

The wiper 35 is connected to a drive source (such as a motor). Fed with a driving force from the drive source, the wiper 35 can reciprocate horizontally (in the directions of arrow YY’). During recovery operation, the wiper 35 is disposed between the ink collection tray 80 and the recording portion 9.

The ink collection tray 80 can store liquid containing ink and cleaning liquid. As described above, the ink collection tray 80 can reciprocate between the first and second positions along the guide rails 70a and 70b. As described above, the ink collection tray 80 is fed with the driving force from the driving device 81 to reciprocate. The detailed configuration of the ink collection tray 80 is as follows.

As shown in FIGS. 7 to 10, the ink collection tray 80 includes a first collection portion 82, a second collection portion 83, and a protrusion 66. When the ink collection tray 80 is at the first position, the first collection portion 82 faces the ink ejection surface F1 of the recording head 17b. When the ink collection tray 80 is at the first position, the second collection portion 83 faces the ink ejection surfaces F1 of the recording heads 17a and 17c.

The first and second collection portions 82 and 83 each has a water storage portion 87. The water storage portion 87 is located below the recording head 17b. The water storage portion 87 receives the ink and cleaning liquid that have fallen in wiping operation and stores them as liquid L1. As described above, the water storage portion 87 is previously loaded with water.

The detailed configuration of the water storage portion 87 is as follows. The water storage portion 87 has an inclined surface 89 and a bottom groove portion 90. The inclined surface 89 is a surface that is inclined downward from opposite ends toward the middle along the horizontal direction. The bottom groove portion 90 is connected to each of a pair of inclined surfaces 89 at a position between the pair of inclined surfaces 89. The pair of inclined surfaces 89 and the bottom groove portion 90 form substantially a V-shape, with the bottom groove portion 90 as the bottom.

A discharge port 63 is formed in the bottom groove portion 90. The discharge port 63 is an opening that leads out of the water storage portion 87. One end of the discharge tube 61 is connected to the discharge port 63 of the second collection portion 83. On the other hand, the discharge port 63 of the first collection portion 82 communicates with the discharge port 63 of the second collection portion 83 via a discharge passage 63a in the ink collection tray 80. The discharge passage 63a extends with a downward slope from the discharge port 63 of the first collection portion 82 to the discharge port 63 of the second collection portion 83. The liquid L1 stored in the water storage portion 87 of the first collection portion 82 flows into the discharge tube 61 through the discharge passage 63a.

The protrusion 66 is provided at the back of the water storage portion 87 of the second collection portion 83. The protrusion 66 protrudes downward from the water storage portion 87 toward the base portion 79. The tip end of the protrusion 66 is inclined with a downward slope from a middle part to an end part of the ink collection tray 80 along the sheet width direction. The tip end of the protrusion 66 is parallel to the second opposing face 65a. The detailed configuration of the protrusion 66 is as follows.

The protrusion 66 has a base 66a and a plurality of ribs 66b. The base 66a is provided at the back of the water storage portion 87. The base 66a extends from the back of the water storage portion 87 toward the second opposing face 65a.

The plurality of ribs 66b are provided on the base 66a. The plurality of ribs 66b protrudes downward from the base 66a toward the second opposing face 65a. Of the plurality of ribs 66b, the tip end of the rib 66b that is closest to the bottom groove portion 90 along the sheet width direction is farther from the first opposing face 64 along the top-bottom direction than the tip ends of the other ribs 66b. The farther away a rib 66b is from the bottom groove portion 90 along the sheet width direction, the farther away the tip end of the rib 66b is from the first opposing face 64 along the top-bottom direction.

The tip end of the protrusion 66 mentioned earlier refers to the tip ends of the ribs 66b. That is, the straight line connecting together the tip ends of the ribs 66b is parallel to the second opposing face 65a. In other words, the inclination angle of the straight line mentioned above is substantially equal to the inclination angle θ.

When the ink collection tray 80 is at the first position, the tip end of the protrusion 66 (more specifically, the tip ends of the ribs 66b) faces the second opposing face 65a across the accommodation space A1. In other words, in this state, the accommodation space A1 is defined by the tip ends of the ribs 66b and the second opposing face 65a.

The waste ink storage container 62 is a container that can store the liquid L1. The waste ink storage container 62 is connected to the other end of the discharge tube 61. The liquid L1 stored in the water storage portion 87 flows into the waste ink storage container 62 through the discharge tube 61.

The discharge tube 61 is a tube made of a resin material with a predetermined elasticity. In other words, the discharge tube 61 is made of a flexible material with a predetermined restoring force. Also, the discharge tube 61 is made of a resin material with a relatively slippery surface. As such a resin material, the discharge tube 61 is made of, for example, fluororesin.

The discharge tube 61 is originally wound around a reel, and a predetermined length of it is cut off and used in the maintenance unit 19. The discharge tube 61 wound around a reel has a curling tendency, which it retains after it is cut out. Owing to the predetermined elasticity and the curling tendency described above, the discharge tube 61 has a curved shape such that it can be accommodated in the accommodation space A1 without an external force being applied to it.

One end of the discharge tube 61 is located above the other end of the discharge tube 61. More specifically, one end of the discharge tube 61 is located above the apex of the second opposing face 65a (the tip end part of the guide spacer 65 along the top-bottom direction). The other end of the discharge tube 61 is located below the first opposing face 64.

One end of the discharge tube 61 is fixed to the ink collection tray 80 with a fixing member 61a. The other end of the discharge tube 61 is fixed at a fixed position with a fixing member 61b. The fixing members 61a and 61b are brackets that fix the tube. As the ink collection tray 80 moves between the first and second positions, one end of the discharge tube 61 also moves, while the other end of the discharge tube 61 remains stationary.

The discharge tube 61 is in contact with the guide spacer 65. More specifically, when the ink collection tray 80 is at the first position, the discharge tube 61 is in contact with the second opposing face 65a. When the ink collection tray 80 is at the second position, the discharge tube 61 is in contact with at least an upstream edge part of the second opposing face 65a in the sheet conveying direction (the direction of arrow X).

### 4. Recovery operation

The printer 100 performs recovery operations on the recording heads 17a to 17c when starting printing after a long period of inactivity and during intervals between printing sessions in preparation for subsequent printing. Recovery operation is operation for cleaning the ink ejection surfaces F1 of the recording heads 17a to 17c. Specifically, the operation proceeds as follows.

First, the flushing control portion 110c outputs an instruction to perform recovery operation. Then, as shown in FIGS. 7 and 8, the driving device 81 moves the ink collection tray 80 to the first position.

In this state, the driving device 81 moves the ink collection tray 80 upward. As a result, the wiper 35 makes contact with the ink ejection surface F1 (see FIG. 5). The wiper 35 then performs wiping operation. Specifically, the operation proceeds as follows.

Ink is pushed out of the ink ejection ports 18 (purging). At the same time, cleaning liquid is supplied from the cleaning liquid supply ports 60a to the cleaning liquid supply surface F2. Then, the wiper 35 in contact with the ink ejection surface F1 reciprocates horizontally (along the direction of arrow YY’) across the ink ejection surface F1 (see FIG. 5). In other words, meanwhile, the wiper 35 slides across the ink ejection surface F1 and across the cleaning liquid supply surface F2.

The ink pushed out onto the ink ejection surface F1 in wiping operation is wiped off by the wiper 35 together with the cleaning liquid. The wiped-off ink and cleaning liquid fall downward to be collected in the ink collection tray 80 (see FIG. 8).

As described above, the ink collection tray 80 (more specifically, the water storage portion 87, which will be described later) is previously loaded with water. The fallen ink and cleaning liquid are stored in the ink collection tray 80 (more specifically, in the water storage portion 87, which will be described later) in the form of liquid L1 mixed with the water there. In the liquid L1, the ink and the cleaning liquid may each be dissolved in water, or may remain undissolved and separated.

When wiping operation is complete, the printer 100 goes into a state in which recovery operation is not in progress. Specifically, the driving device 81 moves the ink collection tray 80 downward. At this time, the wiper 35 moves away from the ink ejection surface F1. Then, as shown in FIG. 9, the driving device 81 moves the ink collection tray 80 to the second position.

### 5. Operation of accommodating the discharge tube 61 in the accommodation space A1

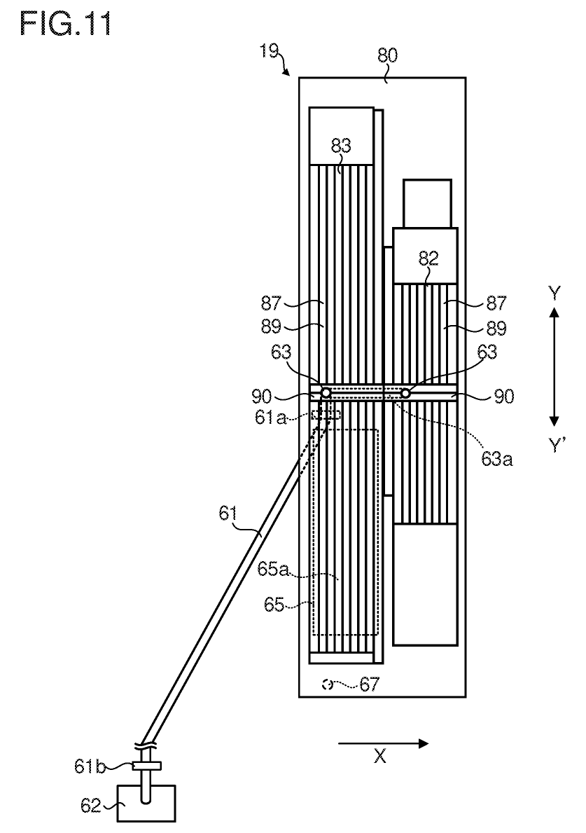

FIG. 11 is a plan view of the ink collection tray 80 at the first position as seen from above. As shown in FIGS. 7 and 11, when the ink collection tray 80 is at the first position, the discharge tube 61 elastically deforms to be in an extended state. In this state, the discharge tube 61 elastically deforms so as to describe a straight line from where it is fixed with the fixing member 61a to where it is fixed with the fixing member 61b.

As described above, the discharge tube 61 is in contact with the guide spacer 65. As described above, the second opposing face 65a is inclined. And the other end of the discharge tube 61 is located below the first opposing face 64. Thus, while the ink collection tray 80 is moving from the first position to the second position, the discharge tube 61 is guided by the guide spacer 65 (more specifically, the second opposing face 65a) to enter the accommodation space A1.

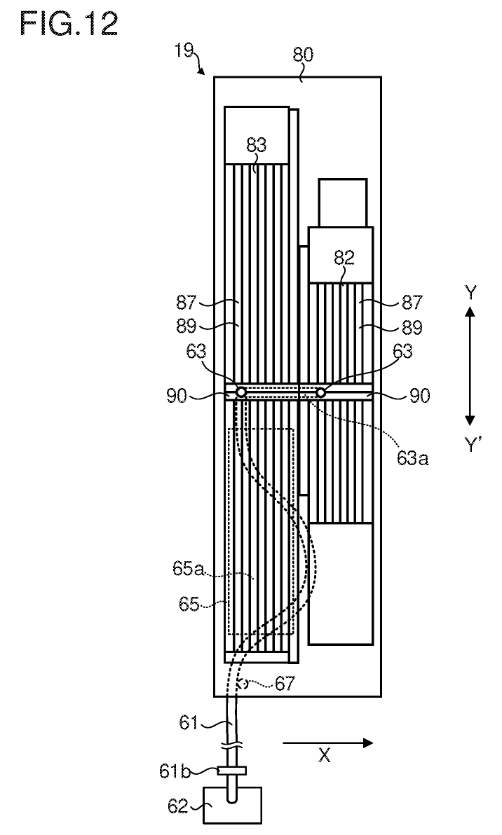

FIG. 12 is a plan view of the ink collection tray 80 at the second position as seen from above. While the ink collection tray 80 is moving from the first position to the second position, the discharge tube 61 makes contact with the projection 67. When the ink collection tray 80 moves toward the second position in this state, the curling tendency of the discharge tube 61 acts as a restoring force to ease its deformation into the curved shape described above. As a result, as shown in FIG. 12, the part of the discharge tube 61 from where it is fixed with the fixing member 61a to where it is in contact with the projection 67 curves so as to bulge toward the back of the accommodation space A1 in the sheet conveying direction (the direction of arrow X).

When the discharge tube 61 is accommodated in the accommodation space A1, it is held between the guide spacer 65 and the protrusion 66. As a result, the discharge tube 61 is held in the curved shape described above. This helps prevent the discharge tube 61 from interfering with the movement of other maintenance units 19.

The discharge tube 61 forms a passage that descents from one end (the end close to the discharge port 63) to the other end (the end close to the waste ink storage container 62). When the discharge tube 61 is accommodated in the accommodation space A1, it is held in the position described above. This makes it possible to prevent the discharge tube 61 from unintentionally deforming into a shape that has an upward slope from midway or from bending midway. It is thus possible to prevent backflow of the liquid L1 resulting from blockage of the discharge tube 61.

With the configuration described above (the configuration in which the discharge tube 61 is guided into the accommodation space A1 by the guide spacer 65), the printer 100 can prevent complication of the configuration around the maintenance unit 19. That is, without an undue increase in its size, the printer 100 can properly guide the discharge tube 61 into the accommodation space A1 to accommodate it there and can hold the discharge tube 61 in a proper position in the accommodation space A1.

The embodiment described above is not meant to limit the scope of the present disclosure, which thus allows for any modifications without departure from the spirit of what is disclosed herein. For example, the number of ink collection trays 80 and their arrangement direction are not particularly limited, and may be appropriately determined according to the number of recording heads disposed in each of the line heads 11Y to 11K.

For example, while the embodiment described above deals with a guide spacer 65 made of polyacetal resin, this is not meant as any limitation. It is preferable to use a relatively slippery material for the guide spacer 65. Here, whether a material is “relatively slippery” can be determined based on its slipperiness derived from a coefficient of friction, surface condition, or the like.

Likewise, while the embodiment described above deals with a discharge tube 61 made of, for example, fluororesin, this is not meant as any limitation. It is preferable to use a relatively slippery material for the discharge tube 61.

The present disclosure is applicable to an inkjet recording apparatus provided with an ink collection tray that receives ink pushed out from an ink ejection surface of a recording head. According to the present disclosure, it is possible to provide an inkjet recording apparatus that can prevent false detection of a clog with waste liquid discharged from an ink collection tray.

What is claimed is:

1. An inkjet recording apparatus comprising:
a recording head having an ink ejection surface from which ink is ejected;
an ink collection tray disposed at a first position facing the ink ejection surface during recovery operation for the recording head, the ink collection tray being able to store liquid containing the ink falling from the ink ejection surface;
a driving device that gives a driving force to the ink collection tray to reciprocate the ink collection tray between the first position and a second position where the ink collection tray does not face the ink ejection surface;
a discharge tube with one end thereof connected to the ink collection tray, the discharge tube discharging the liquid stored in the ink collection tray from one end thereof to another end thereof;
a waste ink storage container that is connected to the other end of the discharge tube, the waste ink storage container receiving and storing the liquid discharged from the discharge tube; and
a control portion that controls the driving device such that the ink collection tray is located at the first position when the recovery operation for the recording head is in progress, and that the ink collection tray is located at the second position when the recovery operation is not in progress,
wherein
an accommodation space that can accommodate the discharge tube is formed below the ink collection tray,
the discharge tube is made of a flexible material with a predetermined restoring force, the discharge tube elastically deforming to enter the accommodation space to be accommodated therein while the ink collection tray is moving from the first position to the second position.

2. The inkjet recording apparatus according to claim 1, further comprising:
an opposing portion that faces the ink collection tray across the accommodation space along a top-bottom direction; and
a guide spacer that protrudes from a first opposing face of the opposing portion facing the ink collection tray toward the ink collection tray, the guide spacer making contact with the discharge tube,
wherein
the guide spacer is a face that faces the ink collection tray, the guide spacer having a second opposing face that is inclined to have a downward slope from one end of the discharge tube accommodated in the accommodation space to the other end of the discharge tube, and
while the ink collection tray is moving from the first position to the second position, the discharge tube is, at a part thereof in contact with the guide spacer, guided by the guide spacer to enter the accommodation space.

3. The inkjet recording apparatus according to claim 2, wherein
the ink collection tray has:
a water storage portion that faces the recording head at the first position, the water storage portion receiving and storing ink falling from the recording head; and
a protrusion that protrudes from a back of the water storage portion toward the opposing portion,
wherein
the accommodation space is formed between the guide spacer and the protrusion.

4. The inkjet recording apparatus according to claim 3, wherein
when the ink collection tray is at the second position, the discharge tube is held in the accommodation space by being held between a tip end of the protrusion in a protruding direction thereof and the second opposing face.

5. The inkjet recording apparatus according to claim 4, wherein
an inclination angle of the second opposing face is at least three degrees or more with respect to a plane.

6. The inkjet recording apparatus according to claim 1, wherein
the discharge tube has a curved shape such that the discharge tube can be accommodated in the accommodation space without an external force being applied to the discharge tube,
as the waste ink storage container moves from the second position to the first position, the discharge tube elastically deforms so as to describe a straight line,
as the waste ink storage container moves from the first position to the second position, the discharge tube deforms into the curved shape with the restoring force to be accommodated in the accommodation space.

7. The inkjet recording apparatus according to claim 2, wherein
the guide spacer is made of polyacetal resin.

8. The inkjet recording apparatus according to claim 1, wherein
the discharge tube is made of fluororesin.

9. The inkjet recording apparatus according to claim 1, wherein
one end of the discharge tube is located above the other end of the discharge tube.
